(19) United States
(12) Patent Application Publication
(10) Pub. No.: US 2018/0036875 A1
(43) Pub. Date: Feb. 8, 2018

(54) Ergonomic Collapsible Handle

(71) Applicant: Daniel Ernest Seger, Laurel, MD (US)

(72) Inventor: Daniel Ernest Seger, Laurel, MD (US)

(21) Appl. No.: 15/227,654

(22) Filed: Aug. 3, 2016

(51) Int. Cl. B25G 1/02

(52) U.S. Cl. CPC B25G 1/02

(57) ABSTRACT

A mechanism able to be attached to, or built into, a surface of an object such that it can then be manipulated to create an ergonomic handle for the objects' use. This mechanism is capable of configuring in both a flat-laying and a graspable protruding position.

### BACKGROUND OF INVENTION

Tablet personal computers (PCs) are an increasingly common convenience in modern lives. The quest of the technology industry to get them as thin and light as possible is driven by the fact that their form factor is not conducive to holding them for long periods of time. Regardless of how thin and light a tablet becomes, it will always be inconvenient to hold, especially as bezels become thinner and thinner. A new method for holding a tablet is needed.

A solution to the holding problem needs to be just as functional as grasping the tablet itself, while allowing maintaining or improving the utility and convenience of any device it's attached to. The present invention achieves this by offering the user a means of holding their tablet, or another object, comfortably and ergonomically, which also conveniently disappears when it is no longer needed.

Able to be built into a tablet's casing or attached to a tablet or other object via a case, or other method, this innovation will allow both the tablet industry and the accessory industry to further differentiate products and offer the consumer enhanced experiences and even greater health.

Though the innovation is conceptualized as providing ergonomic handles for a tablet PC, it is not limited to this use case. This innovation could easily be applied to other products to enhance their inherent functionality and convenience. Anything that would be enhanced by having a collapsible handle could benefit from having this innovation installed.

A great example of an alternate use is in the kitchen, with pot and pan lids. Currently, these lids have fixed, protruding, handles, which renders them impossible to stack so they are guaranteed to take up far too much space in one's cabinets. This innovation could solve that problem by allowing them to be stacked when stored.

### BRIEF SUMMARY OF DRAWINGS

FIGS. 1 through 9 feature a preferred embodiment capable of forming a graspable protrusion along two different dimensional planes. It consists of 9 rigid sections connected to one another via attached hinged. FIGS. 1-5 depict this preferred embodiment flat in its stored position, whereas FIGS. 6-9 depict this preferred embodiment in its use position, ready to be grasped. FIGS. 6 and 7 introduce directional markers to depict the embodiment in its use position along two directional planes. FIGS. 1, 2, 6, and 7 depict this embodiment separate from its frame, and FIGS. 3, 4, 5, 8, and 9 depict it within the track/rail of its frame.

FIGS. 10 through 14 depict an alternative preferred embodiment capable of forming a graspable protrusion along a single dimensional plane. This embodiment consists of 3 rigid sections designed to be connected to one another by sliding a pin through them, which, when done, forms a hinge. FIGS. 10 and 13 feature this embodiment in its stored position while FIGS. 11 and 14 feature this embodiment in its use position. FIG. 12 depicts the frame and track/rail for this alternate embodiment. FIGS. 10 and 11 depict this embodiment without a frame or track/rail, whereas FIGS. 13 and 14 depict it within the track/rail of its frame.

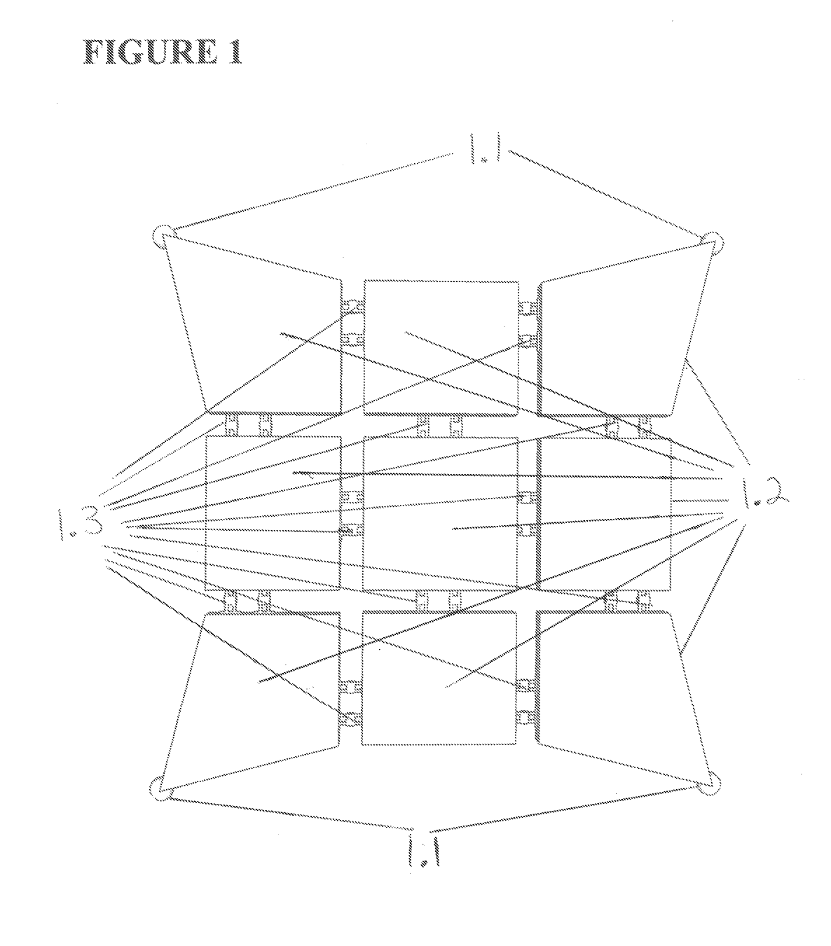

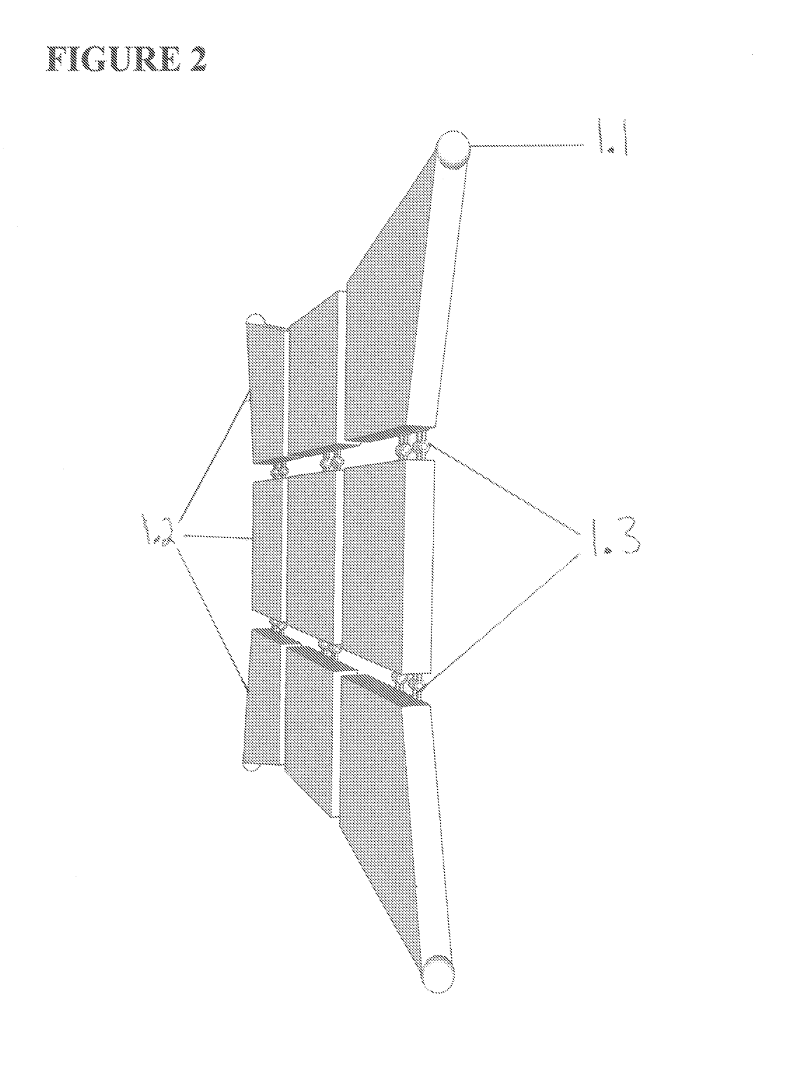

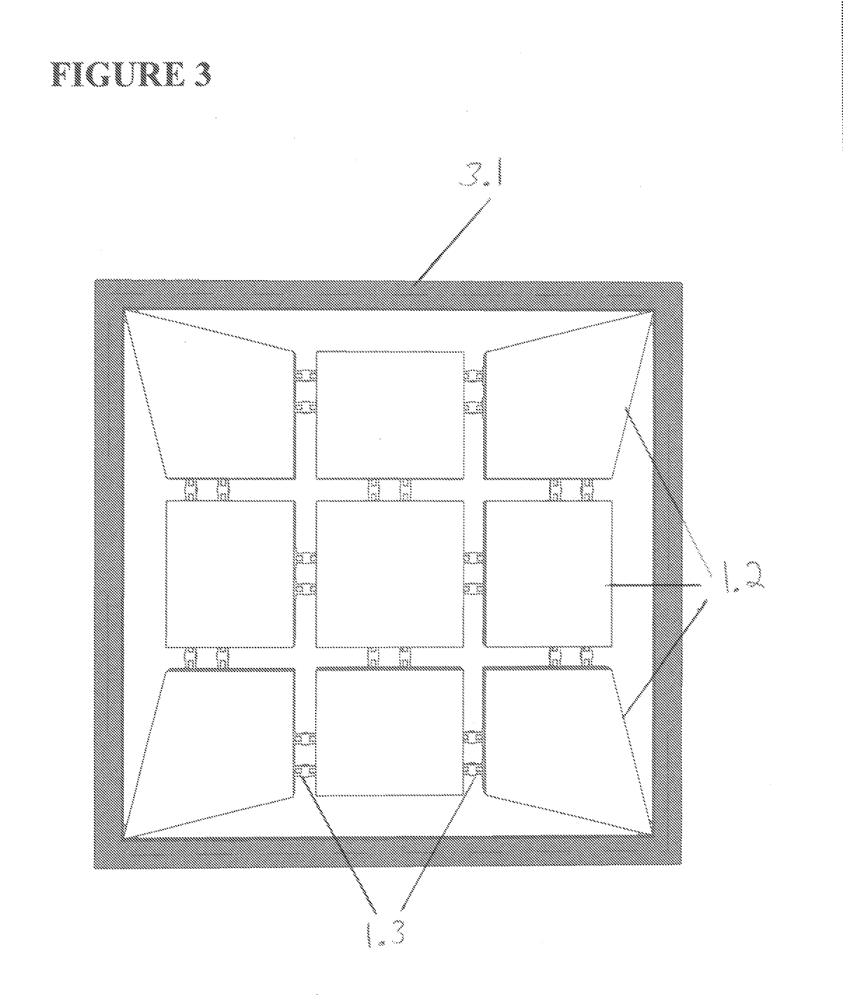

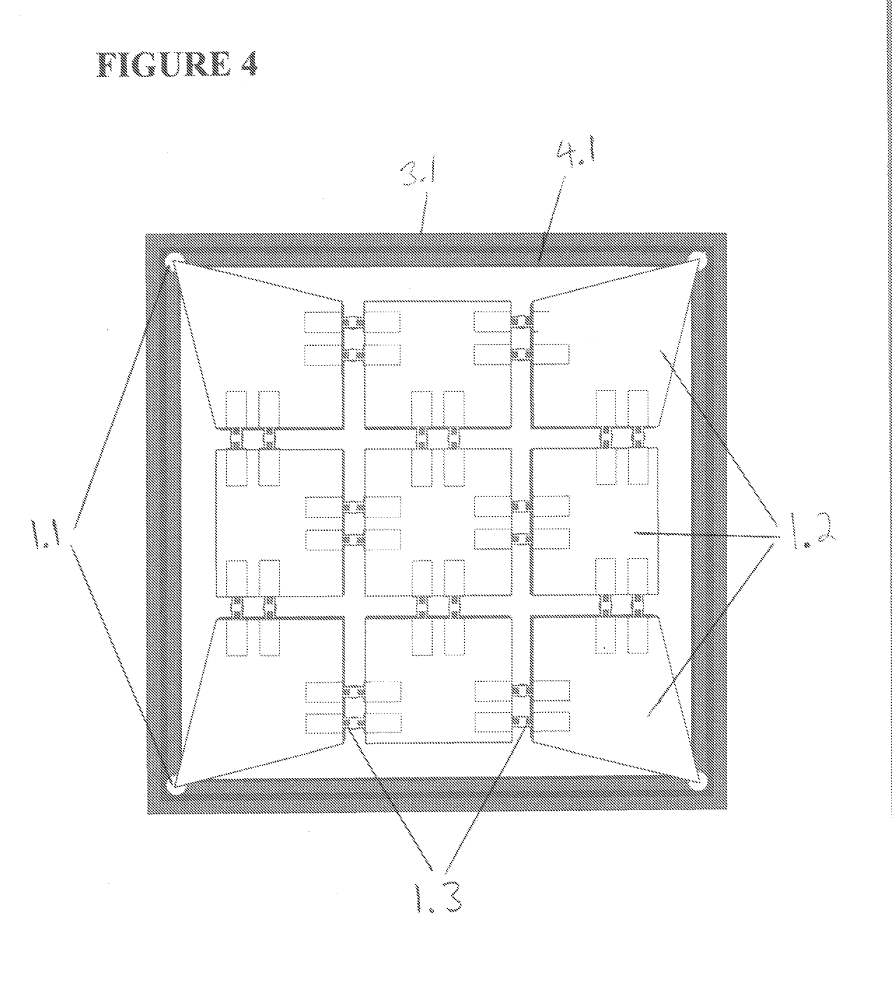

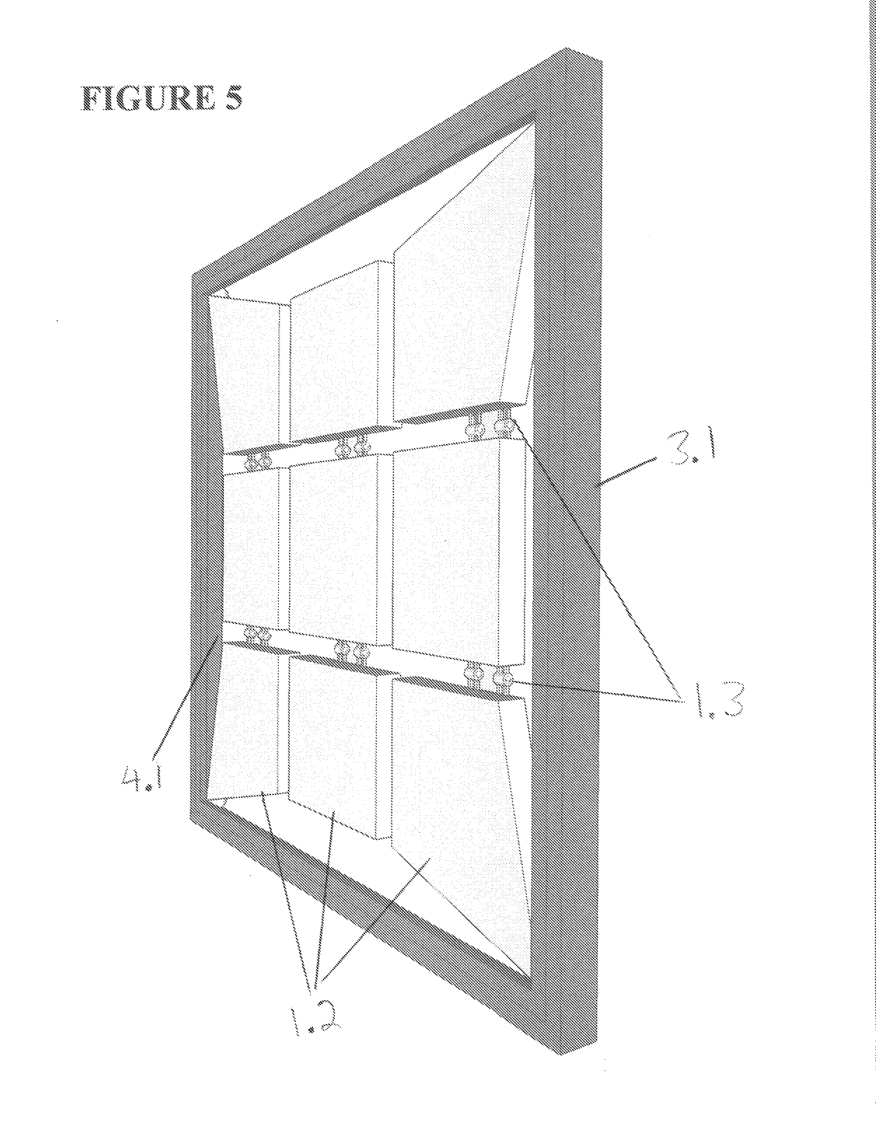

### LABELS

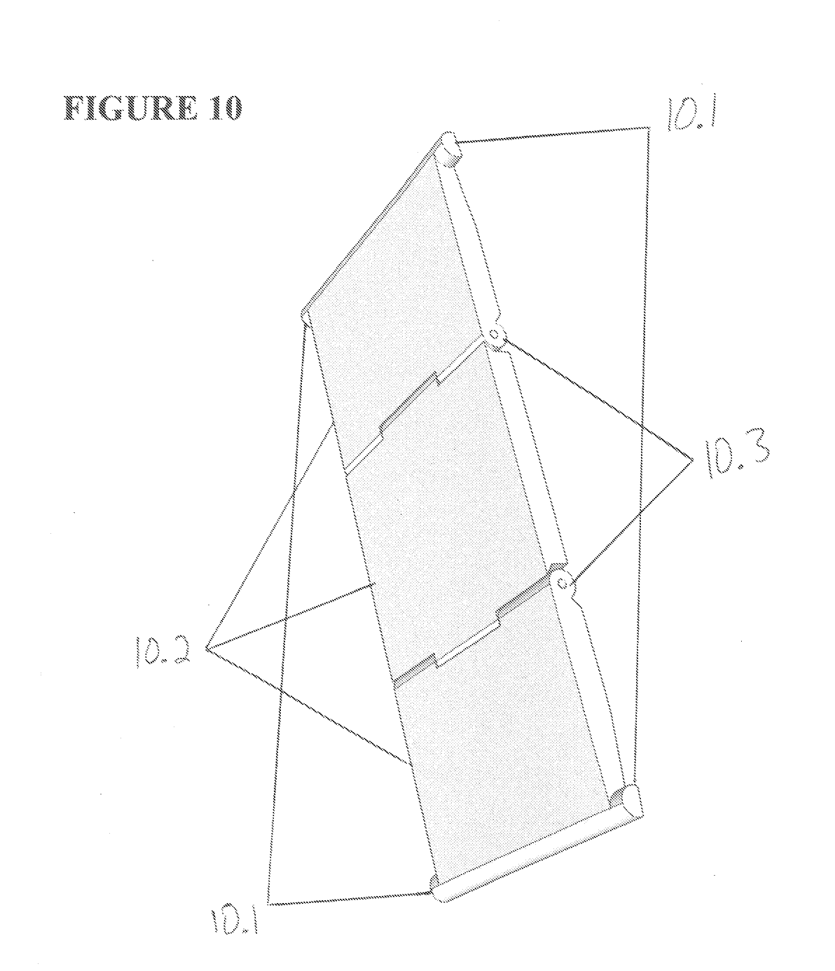

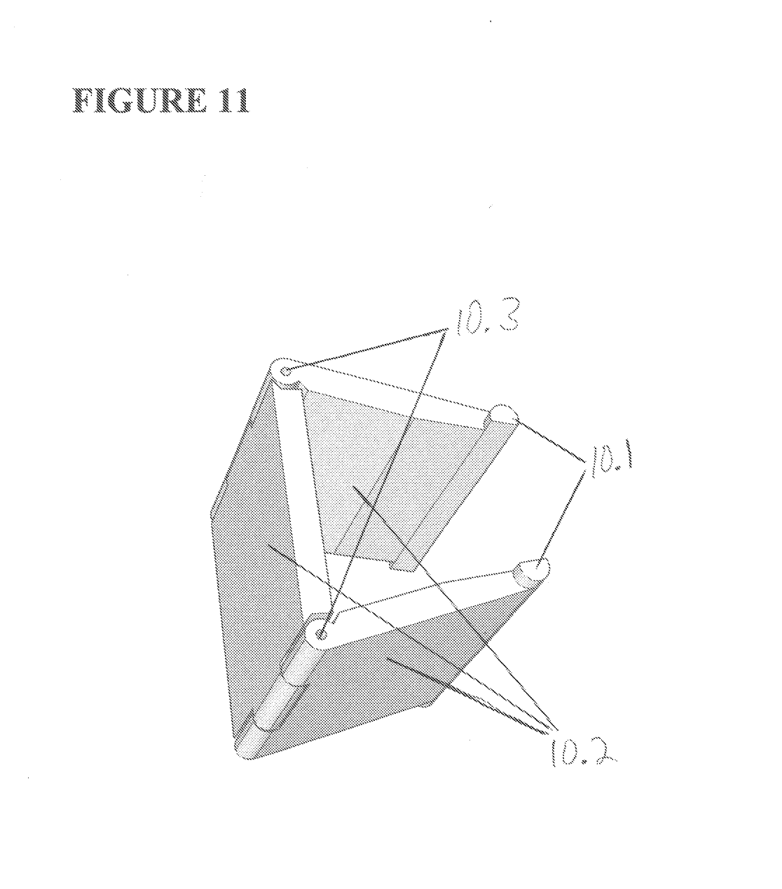

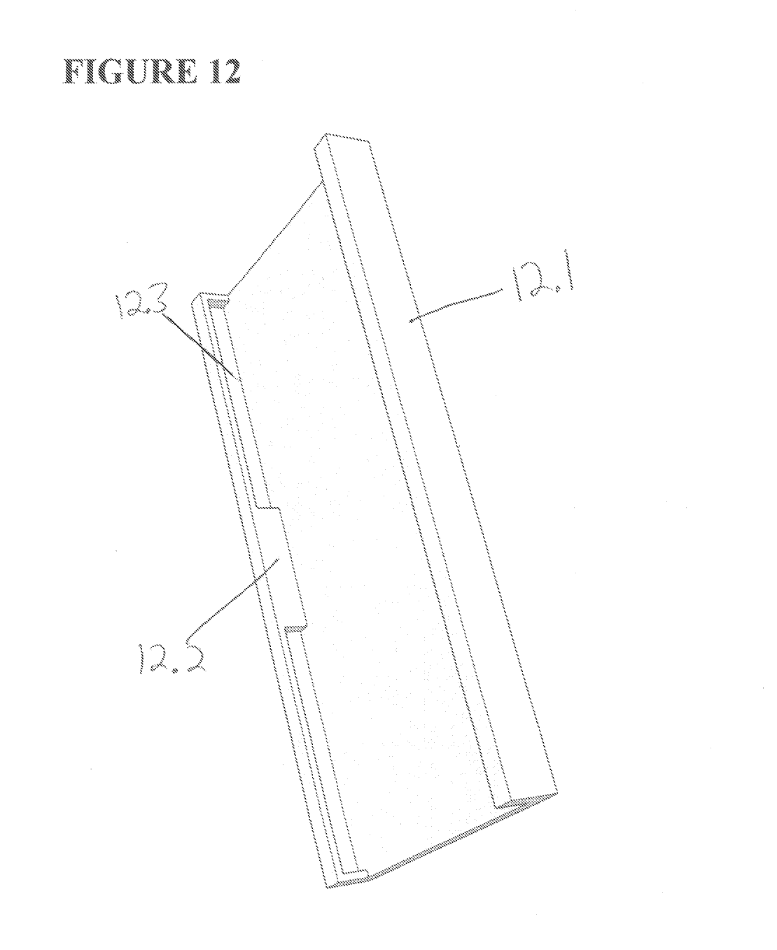

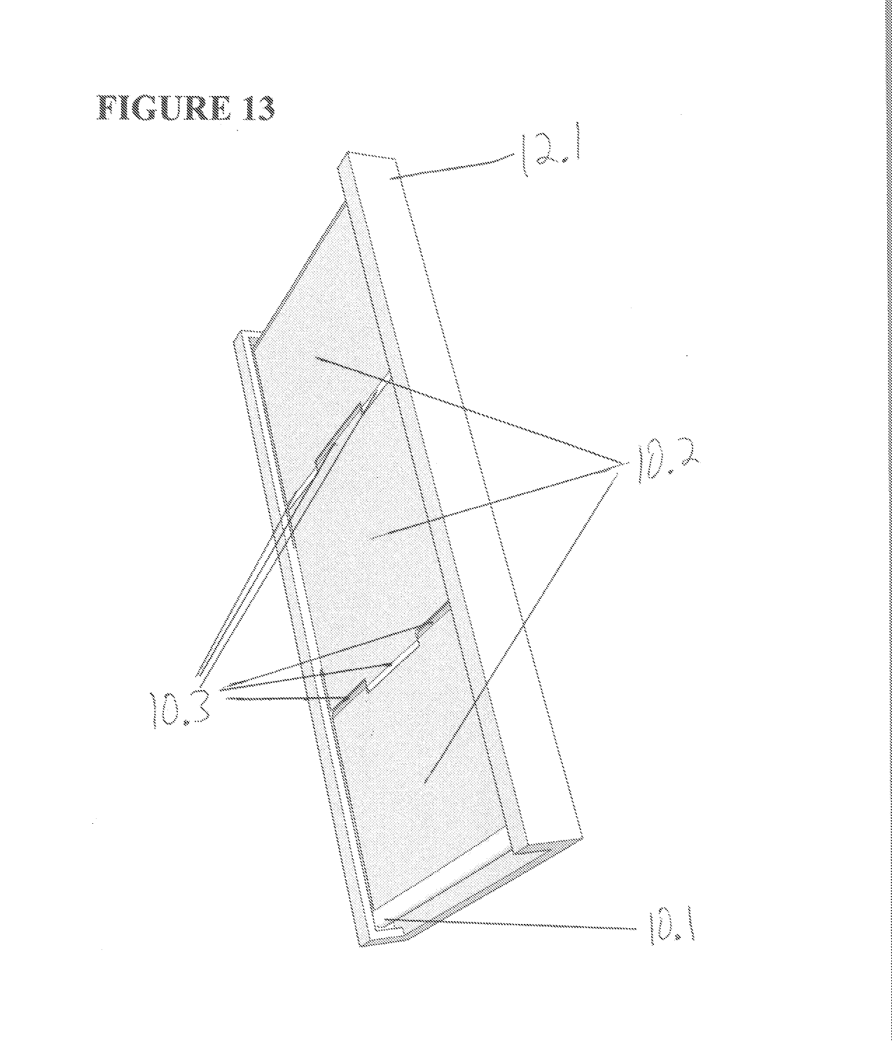

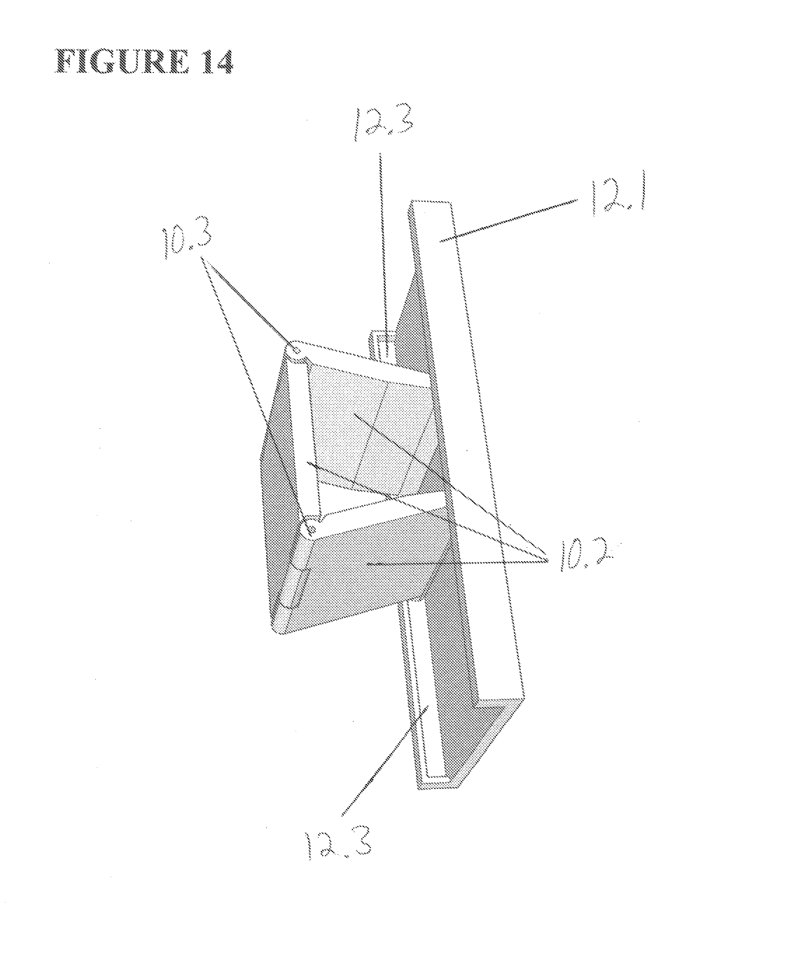

1.1: Part of a rigid section designed to slide on its corresponding track, shaped as spheres in this embodiment to allow for multiple directional planes of operation.
1.2: Rigid sections
1.3: Connections between rigid section (Represented in these preferred embodiments as hinges)
3.1: A frame for the depicted preferred embodiment, which in this embodiment is shaped such that it also contains the rail/track.
4.1: The underside of the frame, which in this embodiment forms the rail/track for the rigid sections to move along.
10.1: Part of a rigid section designed to slide on its corresponding track, shaped as cut cylinders in this alternate embodiment to allow for use in a single directional plane.
10.2: The rigid sections of this alternate preferred embodiment.
10.3: The connections of this alternate preferred embodiment, depicted here as part of the rigid sections that would accept a pin to form a hinge.
12.1: The frame of the alternate preferred embodiment of FIGS. 10 through 14.
12.2: Apart of the frame of this alternate preferred embodiment, which limits the movement of the rigid sections on the track.
12.3: The underside of the frame, which in this alternate embodiment forms the rail/track for the rigid sections to move along.

### DESCRIPTION OF INVENTION AND DRAWINGS

The present invention consists of rigid sections (1.2 and 10.2) connected in such a way (1.3 and 10.3) that they can fold away from an object. Both embodiments pictured rely on hinges for this connection, but a flexible material could be substituted and still allow for the functioning of the device. In both pictured preferred embodiments, the four outermost corners of the rigid sections are shaped to form protrusions (1.1 and 10.1) designed to protrude under the frame (3.1 and 12.1) onto the rail and/or track (4.1 and 12.3). When the rigid sections are folded away, these protrusions slide along, and are constrained by, the track/rail, which forces the rigid sections to fold predictably into their use position and allows the device to remain connected to the frame and thereby to an attached object.

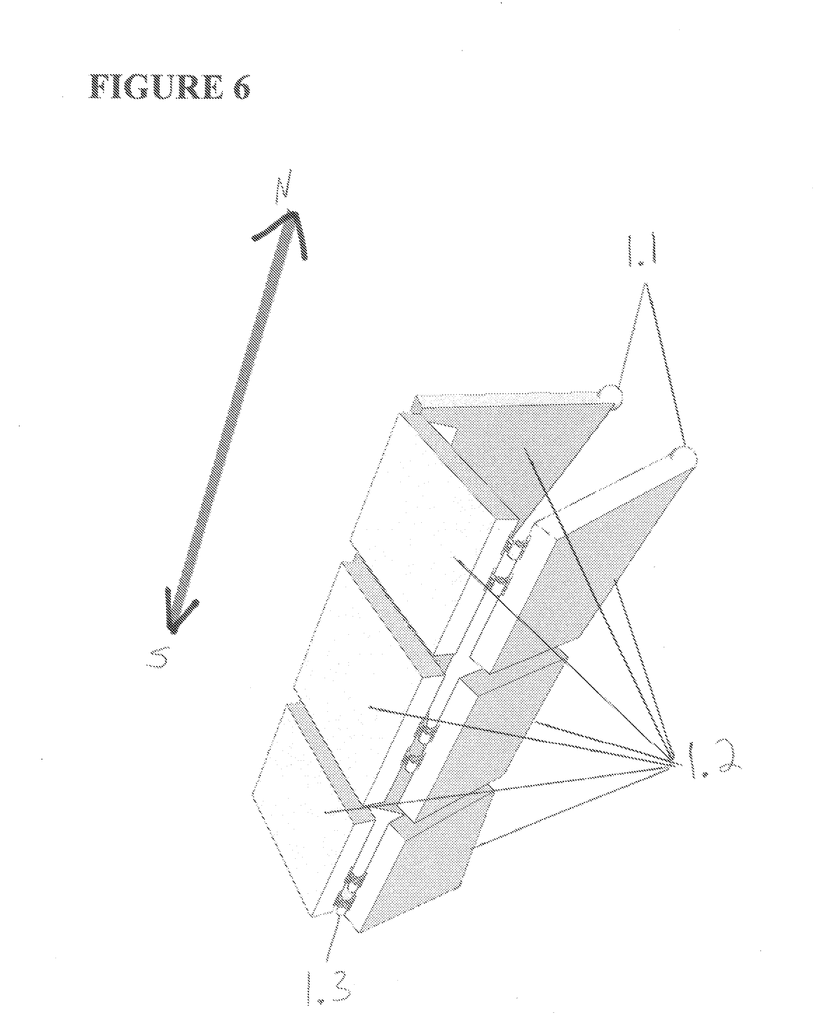

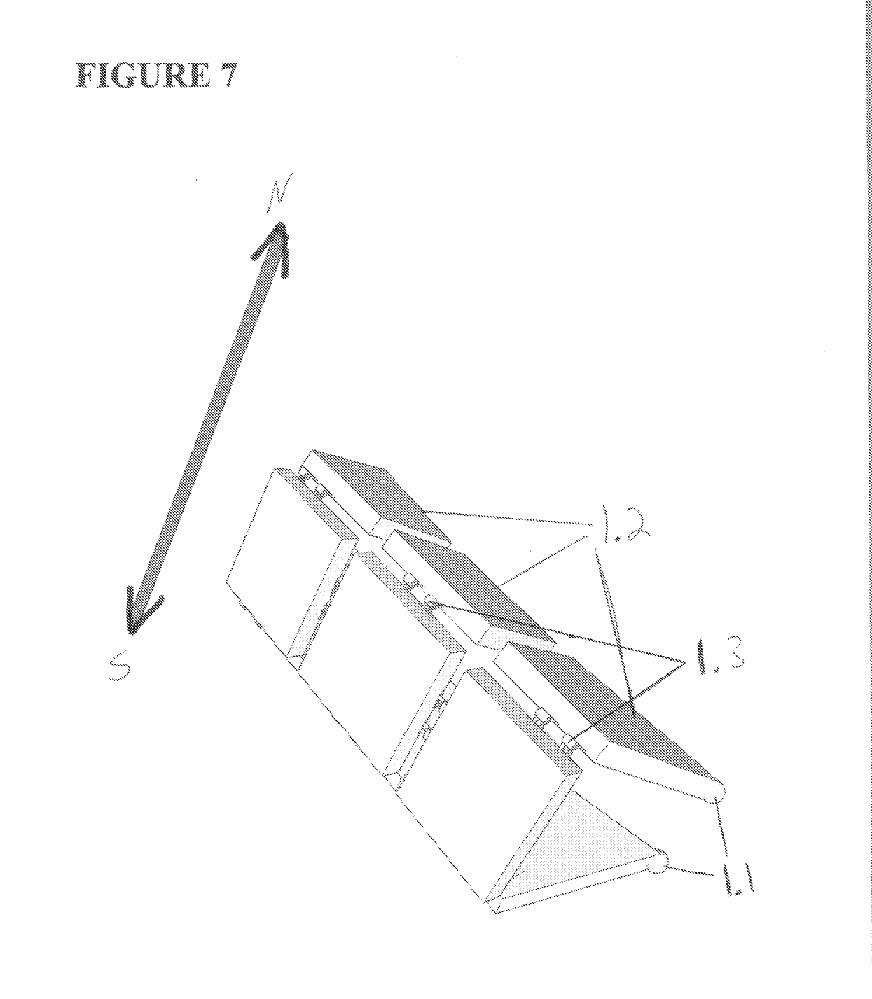

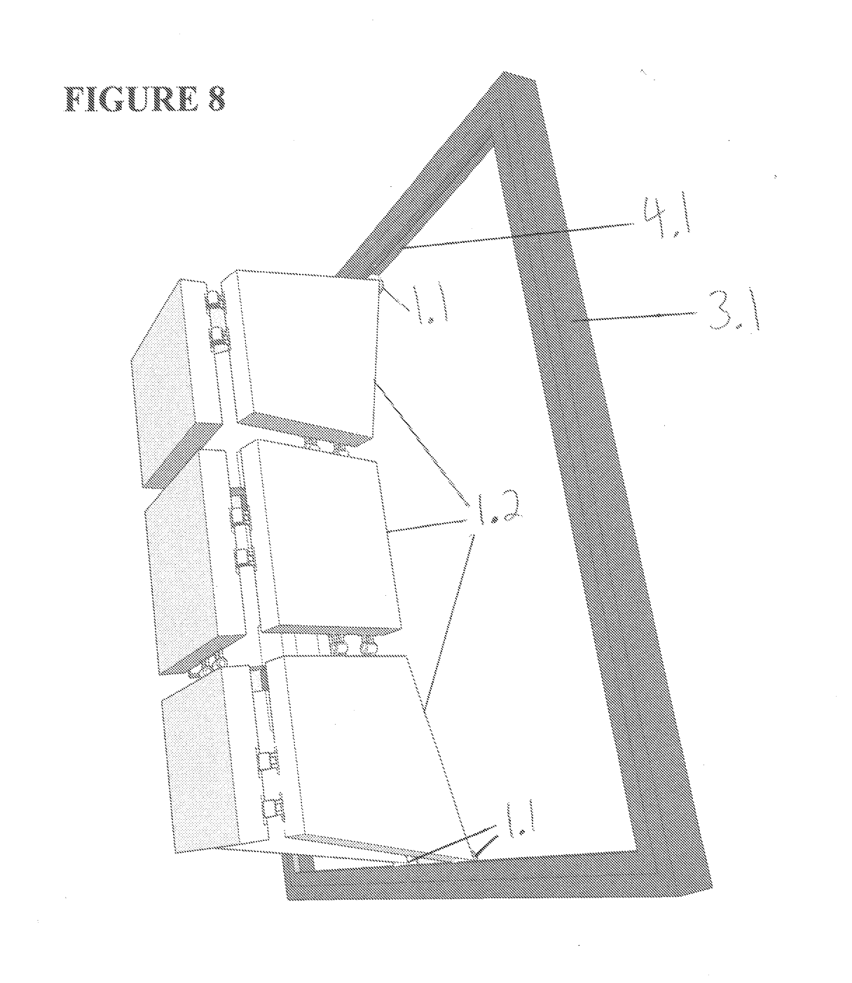

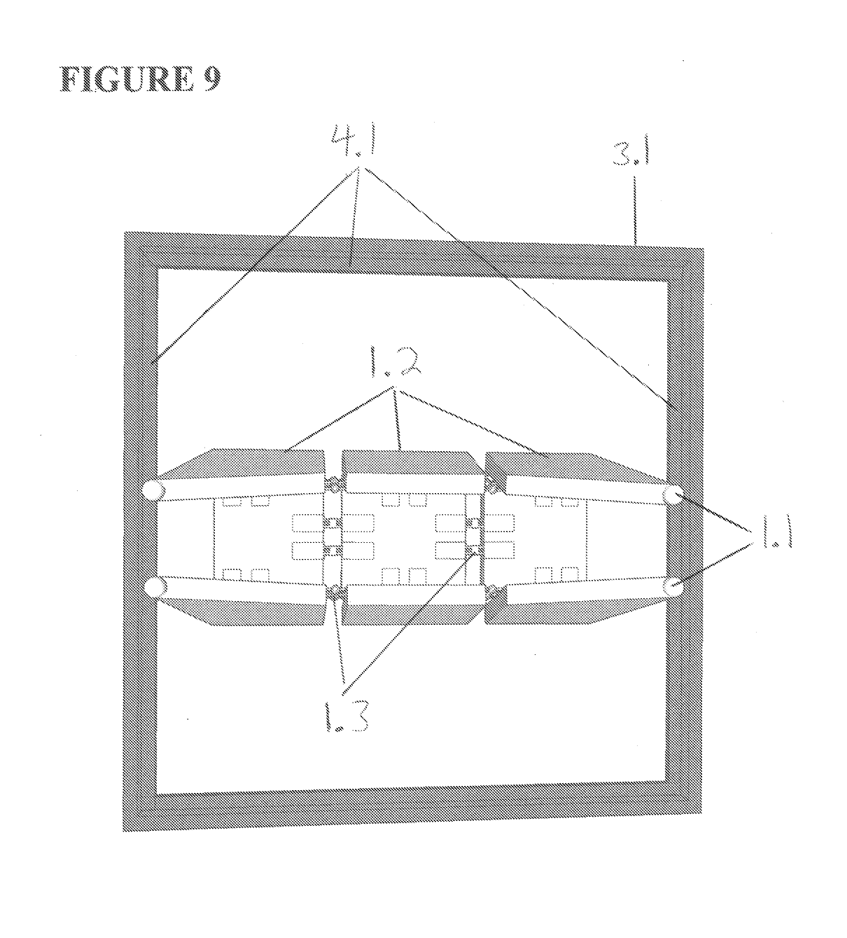

The frame and track/rail of the first preferred embodiment is designed to accommodate the same folding path of its rigid sections along two dimensional planes, whereas that of the alternate preferred embodiment is designed to accommodate the folding motion along a single dimensional plane. The depicted preferred embodiments of the track/rail are shown as a part of the frames of these embodiments, which would be secured to a surface of an object the user desires to grasp ergonomically (not pictured). When in the use position, the connected rigid sections create a grasp-able protrusion on the surface of an object (as pictured in FIGS. 6, 7, 8, 9, 11 and 14). The present invention transfers forces from a grasping hand via the protrusions of the rigid sections to the frame and track/rail, which thereby transfers those forces to an attached object.

The first preferred embodiment of this invention would allow a user to hold an object in two orientations with the same ergonomic grip. For example, a tablet PC could be held in landscape or portrait mode while the user's wrist and hands remain in the same ergonomic positions. It is understood that the present invention is not limited to the described and pictured embodiments herein. For example, the shapes and sizes of the rigid sections could be altered, yielding a graspable protrusion of differing dimensions, which would still be graspable with the same grip from either the landscape or the portrait position of the tablet PC. Though specifically shaped rigid sections, protrusions, frames, tracks/rails, and hinges are pictured, it is understood that the present invention is not limited to these preferred embodiments, and that these elements can be changed so much as they still allow the utility of the present invention.

The present invention claims:

1. A method for the formation of a graspable protrusion via the manipulation of connected rigid sections into a protruding position, hereafter referred to as the use position, from a flat-laying, or stored, position, which includes the following:
a. Connected rigid sections possessing the capacity to form a graspable protrusion via the positioning of said rigid sections, which are connected to one another such that a rigid section may be rotated relative to another rigid section via said connection, and/or may be rotated relative to yet another rigid section, and/or the surface of an object the method is attached to, via said or another connection.
b. The capacity of all said connected rigid sections of said method to be manipulated such that each of said rigid sections may lay flat against a surface of an object, which is hereafter referred to as the stored position.
c. The capacity to be built into and/or otherwise connected and/or attached to a surface of an object such that said object could then be held/used by a user grasping the invention while said method is in the use position.
d. A frame, rail, track, and/or other means for said rigid sections to connect to and utilize said object, which:
i. Allows said rigid sections to move while remaining connected to said object during the operation of said method.
ii. Constrains said rigid sections movements and alignment relative to one another and/or to said connected object such that they form a desired protrusion predictably.
iii. Allows for the transfer of forces between the user and an attached object via said connected rigid sections' linking to said frame, track, and/or rail.
e. A means for a user to manipulate said rigid sections to and/or from a protruding use position to and/or from a flat-laying stored position.

2. The method of the above claim that may also include any combination, including all or none, of the following:
a. The capacity of said connected rigid sections to fold outward from said surface of an object in multiple directional planes, yielding alternative ways to hold, grip, and/or use said object.
b. The capability of said rigid sections to protrude in such away to provide a means to lean a connected object against said graspable protrusion at an angle appropriate for said object's use.
c. A means to lock, or otherwise secure, the invention in its stored position, its use position, or any other position within the invention's operational scope.
d. A means to automate, partially automate, otherwise make easier, or simplify the manipulation, folding, and/or unfolding process of said invention, and/or any or all of its parts.
e. A means to guarantee that all rigid sections fold and/or rotate simultaneously and/or uniformly.

3. The method of the above claims in which said connection(s) of said rigid sections (la) may be a hinge, flexible material, and/or other bendable material and/or combination of materials capable of allowing entities connected with it to rotate relative to one another.

4. The method of the above claims in which said graspable protrusion (la), formed via said connected rigid sections in the use position, is of any dimensions, forms in any directional plane, and/or forms any shape during any time(s) during its operation and/or in the use or stored positions.

5. The method of the above claims in which said rigid sections may form protrusion(s) (la) of any rigidity, firmness, heat or electrical conductivity, strength, and/or other attribute(s) not listed herein.

6. The method of the above claims in which any, all, and/or any combination of, said method's parts may be of any size, dimension, shape, and/or color, and/or are comprised of any material and/or combination of materials.

7. The method of the above claims in which said means of rotating said rigid sections (1e), and/or said means of making said means of rotation easier (2d), may be accomplished manually, mechanically, magnetically, electrically, by any other means, and/or by any combination of means.

8. The method of the above claims in which said rigid sections of said protrusion(s) may be secured, fastened, and/or otherwise connected to said frame, rail, and/or track, by any means and/or any combination of means.

9. The method of the above claims that may be secured, stuck, strapped, fastened, buttoned, or otherwise attached to a surface of an object by any means.
